(19) United States
(12) Patent Application Publication
(10) Pub. No.: US 2007/0159319 A1
(43) Pub. Date: Jul. 12, 2007

(54) Warning Device and System

(76) Inventor: Ronald Maldonado, Caguas, PR (US)

Correspondence Address: CARLA FERRARI-LUGO LAW OFFICE, PO BOX 988, AGUADILLA, PR, 00605, US

(21) Appl. No.: 11/306,744

(22) Filed: Jan. 10, 2006

(51) Int. Cl. B60Q 1/26

(52) U.S. Cl. 340/468

(57) ABSTRACT

The present invention comprises a device and system for alerting a condition to avoid collisions mainly triggered by tail-gating, an absentminded driver and/or rear approaching bodies. The device and system comprises both audible and visual devices for alerting rear approaching drivers and/or transportation means that they are either getting too close or approaching too fast, thus avoiding a possible vehicle collision. The system is activated by manually actuating an interrupter which will in turn activate an electronic timer which closes the electric circuits of the audible indicating means and the visual indicating means, both indicating means having different time sequences. Wherein the audible indicating means remains active for the time duration that the interrupter is actuated and the visual indicating means becomes active when the interrupter is actuated, but becomes inactive a predetermined period of time after the interrupter is no longer actuated.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

The present invention relates to transportation safety systems, in general and in particular to a warning device and system for alerting a rear approaching driver that it is approaching too fast or getting too close to a forwarding vehicle and/or transportation means.

### BACKGROUND OF THE INVENTION

### Discussion of Prior Art

For many years warning lights at the rear of transportation means, such as automobiles and trucks that are driven on public roads and highways, have been used and considered essential to alert drivers of other transportation means sharing the same roadways to impending changes in speed and position. For instance, red tail lights are normally used during nighttime hours so that other drivers will see the lighted transportation means and/or vehicle; direction signals, also called turn signals, are used to warn other drivers of impending lane change or cornering; stop lights are used, most usually activated by a switch in conjunction with a brake pedal, to warn other drivers that the brakes are being applied.

It is also well known; that on the public highways many accidents happen because one driver may follow another at a distance that is too close for the following driver to react in time to apply his brakes or perform whatever maneuver may be necessary to avoid a collision.

Lightning systems are commonly used to alert rear approaching drivers that the forwarding driver is decelerating or that the approaching driver is approaching too fast or getting to close to the forwarding transportation means and/or vehicle. However, these alerting means are commonly activated through the break system.

Conventional brake light systems for transportation means used worldwide provide rear mounted brake lights that illuminate bright red whenever a brake pedal is depressed and the lights are extinguished when the driver's foot is removed from the brake pedal. To improve the effectiveness of brake lights as warning devices, automobiles have been provided with an additional centrally located brake light placed at approximately eye level with respect to drivers of trailing transportation means, mainly referred to as third break light. Despite such wide spread improvements, rear end collisions continue to occur with substantial frequency, indicating that there is room for improvement.

However, drivers, such as tailgaters or absentminded drivers often approach a forwarding transportation means, and/or vehicle too fast and applying the breaks is not an efficient method for alerting the rear approaching transportation means of the fact that it is too close or approaching too fast towards the forwarding transportation means. In fact, brake actuation is the mechanism most often used by the forwarding transportation means and/or vehicle to alert the rear approaching transportation means of the fact that it is approaching too fast or getting to close to the forwarding transportation means. However, this mechanism is even more prone to causing transportation means collisions and/or accidents.

Also, audible alerting means, such as a horn or buzzer, are more often used to alert of a condition that takes place in front of the forwarding vehicle.

While the aforementioned prior art constitute alerting means for a rear approaching driver, non of them provide for a system or device by which a forwarding transportation means alerts a rear approaching transportation means by means of an audible and/or visual signal of the presence of the forwarding transportation means or of the fact that the rear approaching transportation means is approaching too fast or getting too close to the forwarding vehicle. More so, the present invention provides for a simple, efficient and practical transportation means safety system.

The present invention provides for a device and system for transportation means safety which helps avoid vehicle collisions which may result in bodily injuries, specifically in the neck due to collisions caused by rear approaching drivers. Because it is not dependent on state of the art technology and it's easy to install it's a cost effective alternative for enhancing safety on vehicles which in turn is not a burden either on the manufacturer or on the buyer of the vehicle in terms of transportation means pricing.

### SUMMARY OF THE INVENTION

The device and system comprises an audible device fitted in the rear of a transportation means, a visual device installed in the third break light and an interrupter, located in an accessible position at the front of the transportation means to activate the device and system. Once the driver detects a rear approaching transportation means that gets too close or that is approaching too fast, the driver will activate the system by pressing the interrupter button or the switching arrangement, which in turn will activate the audible and visible device which will warn the rear approaching transportation means that it is too close or moving to fast toward the forwarding transportation means, thus avoiding a possible collision.

A warning device and system for alerting a rear approaching driver of the existence of the forwarding vehicle provides an affordable and unsophisticated means to avoid and or reduce the possibility of a collision. The system provides a mechanism for the user to selectively activate the warning means. Because it provides both a visual and an audible alerting means, it serves as a better and more efficient means to avoid transportation means and/or vehicle accidents.

### BRIEF DESCRIPTION OF THE DRAWINGS

The preferred embodiments of the invention will hereinafter be described in conjunction with the included drawings provided to illustrate and not to limit the invention, wherein like designations denote like elements, and in which:

FIG. 1 shows a rear view of the forwarding vehicle according to a preferred embodiment of the invention.

FIG. 2 shows a diagram illustrating the components of the preferred embodiment of the invention.

### DETAILED DESCRIPTION OF THE INVENTION

The present invention presents a device and system for alerting a condition using at least one of an audio and visual indication means. In the preferred embodiment it is used for alerting an approaching driver that it is getting too close or approaching too fast, in order to avoid a possible transportation means collision. However, it could also be used to indicate a variety of information outside of a vehicle. For example, it could be used to alert other drivers, passengers or pedestrians of an emergency situation, unwanted proximity of pedestrians, or even road or traffic conditions. The present invention is primarily geared towards motor vehicles and in particular towards passenger vehicles, but it can be used within any transportation means. As used herein a “transportation means” can be any means capable of transferring a person form one place to another, including, but not limited to: boats, airplanes, ships, motorcycles, bicycles, tricycles, cars, trucks, skateboards, two-wheel vehicles, three-wheel vehicles, all terrain vehicles, motor vehicles, battery vehicles, hybrid vehicles among others. The device can be used and/or adapted to garments or clothing or it may be provided with proximity detection. For example, a person riding a bicycle could wear a jacket incorporating the invention instead of installing the invention into said bicycle. Moreover, it is also envisioned that a proximity detection means could be integrated with the invention in order to provide automatic activation of the indicating means.

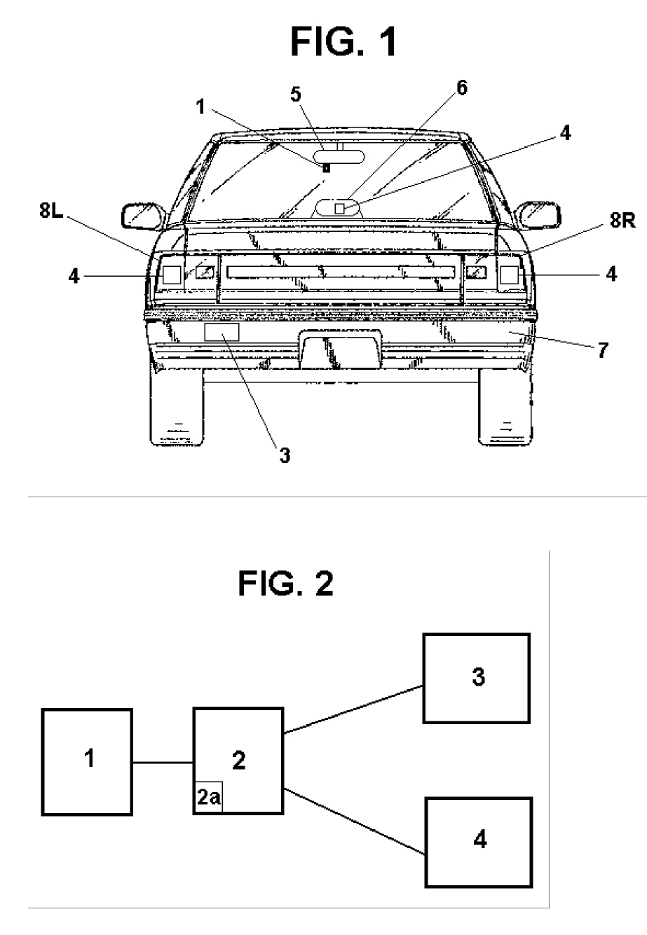

FIG. 1 shows a preferred embodiment of the invention. It shows the rear view of a forwarding vehicle 20 wherein the system will be mounted to alert the rear approaching vehicle that it is getting too close or approaching too fast. FIG. 1 shows a switching arrangement 1 comprising an interrupter, which is mainly a manual switch for activating the system. Although FIG. 1 shows a manual switch, the switching arrangement comprises at least one of: a wired switch, a wireless switch, a sensor, a magnetic switch, and a voice activated switch. In a preferred embodiment of this invention, the switch 1 is located in the rear view mirror 5 of the vehicle. However, it may be located in at least one of a rear view mirror, dashboard, door panel, armrest, console, steering wheel, driver seat, passenger seat, transportation means floor, transportation means roof, and transportation means storage area. FIG. 1 further shows the preferred audio indication means, in this case a horn 3 located in the rear bumper 7 of the vehicle. Alternatively, the audio indication means can be at least one of: buzzer, or any other audible means. In this preferred embodiment the visual indication means is in the form of strobe lights 4, which are located either in the rear stop lights 8L and 8R or in the third break light 6. The visual indication means can also be at least one of: light bulb, LED, and visual display. The visual indication means could also be used to convey information in the form of at least one message such as: “HELP!”, “THANK YOU”, “CAUTION”, “ACCIDENT AHEAD”, “YOU'RE TOO CLOSE!”, among others.

According to this preferred embodiment of the invention, when the driver in the forwarding vehicle 20, detects a tailgater or a transportation means that is approaching too fast or too close, he/she presses the switch 1 located in the rear view mirror 5 in order to activate the system. Once the interrupter is depressed, the system activates a timer 2a as shown in FIG. 2, which will in turn activate the audible device, in this preferred embodiment a horn 3, located in the rear bumper 7 and the visual device, in this preferred embodiment a strobe lights 4, located either in the rear stop lights 8L and 8R or in the third break light 6. Once activated, the audio indication means 3 will emit an audible signal which will last as long as the switching arrangement 1 is actuated. When the switching arrangement 1 is no longer actuated, the visual signal produced by the visual device 4 will continue for a predetermined period of time after the switching arrangement is no longer actuated. The predetermined period of time may be a preset fixed amount of time or could be a user variable amount of time. The predetermined period of time could be at least five (5) to ten (10) seconds.

Alternatively, the system could be wirelessly actuated. For example, a wireless transmitting/receiving means could be provided to transmit and receive an actuation signal, respectively. The transmitting means could be provided in the form of a keychain fob including at least one switch. The transmitting means could be located in a vehicle to receive said wireless actuation signal in order to actuate the indicating means. Moreover, the location of said switch inside the vehicle could make difficult a wired connection between said switch and the rest of the components. Thus, it is also possible to provide the switch with wireless transmitting means, wherein a wireless receiving means located at a remote location inside said vehicle receives the actuating signal and actuates the indicating means accordingly. In another embodiment, the manual switch could be substituted with a proximity sensor that outputs an actuating signal whenever an external object is within a predetermined distance of the vehicle. Alternatively, a voice actuated means could substitute the manual switch to provide hands-free operation of the invention and increase driving safety.

FIG. 2 shows a diagram depicting the main components of the invention including a switching arrangement 1, a controller 2 and a timer circuit 2a, an audio indicating means 3 and a visual indicating means 4. In a preferred embodiment the timer circuit 2a is integrated in to the controller 2. Alternatively the timing circuit could be a separate device from the controller 2 or the timing circuit could perform at least some of the functions of the controller 2. Moreover, the controller 2 and the timer 2a could be implemented by an Application Specific Integrated Circuit (ASIC). In the preferred embodiment, timer circuit 2a is a one-shot timer circuit. However, it is also possible to use any combination of hardwired components such as but not limited to: capacitors, resistors, inductors, and diodes.

The system is activated by manually depressing the switch 1 located at the rear view mirror 5, which in turn activates the controller 2 setting on the timer 2a that activates both the audible device 3 and the visual device 4.

While the preferred embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention as described in the claims.

What is claimed is:

1. A device for alerting a condition comprising:
a switching arrangement;
a timing circuit connected to said switching arrangement; and
at least one indicating means connected to said timing circuit.

2. The device of claim 1, wherein said at least one indicating means comprises at least one of: audio indication means and visual indication means.

3. The device of claim 1, wherein said at least one indicating means comprises at least one of: horn, buzzer, strobe means, light bulb, LED, visual display.

4. The device of claim 1, wherein said at least one indicating means comprises a visual indication means and an audio indication means which are actuated substantially simultaneously.

5. The device of claim 4, wherein the time duration of said visual indication means and said audio indication means vary by a predetermined time period.

6. The device of claim 1, wherein said at least one indication means remains active at least for the time duration of said switching arrangement actuation.

7. The device of claim 6, wherein said at least one indication means comprises an audio indication means that remains active for the time duration of said switching arrangement actuation and a visual indication means that becomes active when said switching arrangement is actuated and becomes inactive a predetermined period of time after said switching arrangement is no longer actuated.

8. The device of claim 1, wherein the switching arrangement comprises at least one of: a manual switch, a wired switch, a wireless switch, a sensor, a magnetic switch, and a voice-activated switch.

9. The device of claim 8, wherein the switching arrangement is selectively located at a user accessible location.

10. The device of claim 9, wherein said switching arrangement is selectively located in transportation means in at least in one of: a rearview mirror, a dashboard, a door panel, an armrest console, a driver seat, steering wheel, a passenger seat, a transportation means floor, a transportation means roof, and a transportation means storage area.

11. The device of claim 1, further comprising a power source connected to said switching arrangement, wherein said power source is selected from the group comprising of at least one of: a battery, a generator, a solar cell, fuse box, and a capacitor.

12. The device of claim 1, wherein said at least one indication means is selectively located at a rear portion of a transportation means.

13. The device of claim 12, wherein said transportation means comprises a vehicle and said at least one indication means comprises an audio indication means substantially located in a bumper.

14. The device of claim 12, wherein said transportation means comprises a vehicle and said at least one indication means comprises a visual indication means substantially located in at least one of: rear stop lights, and a third brake light.

15. A system for alerting a condition in a transportation means comprising:
a switching arrangement;
a timing circuit connected to said switching arrangement; and
at least one indicating means connected to said timing circuit for alerting a condition in said transportation means.

16. The system of claim 15, wherein said switching arrangement is selectively actuated by a user when at least one of: any external body is in close proximity to said transportation means or any external body is approaching said transportation means at a speed faster than the speed of said transportation means.

17. The system of claim 15, wherein said at least one indicating means comprises a visual indication means and an audio indication means which are actuated substantially simultaneously.

18. The system of claim 17, wherein the time duration of said visual indication means and said audio indication means vary by a predetermined time period.

19. The system of claim 15, wherein said at least one indication means remains active at least for the time duration of said switching arrangement actuation.

20. The system of claim 19, wherein said at least one indication means comprises an audio indication means that remains active for the time duration of said switching arrangement actuation and a visual indication means that becomes active when said switching arrangement is actuated and becomes inactive a predetermined period of time after said switching arrangement is no longer actuated.

21. The system of claim 15, further comprising a power source connected to said switching arrangement, wherein said power source is selected from the group comprising of at least one of: a battery, a generator, a solar cell, fuse box, and a capacitor.
